(19) United States
(12) Patent Application Publication
(10) Pub. No.: US 2025/0289308 A1
(43) Pub. Date: Sep. 18, 2025

(54) INFORMATION DISPLAY METHOD, INFORMATION PROCESSING DEVICE, AND RECORDING MEDIUM

(71) Applicant: Panasonic Automotive Systems Co., Ltd., Kanagawa (JP)

(72) Inventors: Yasuhiro TAKADA, Kanagawa Ken (JP); Hiroya OUE, Kanagawa Ken (JP)

(73) Assignee: Panasonic Automotive Systems Co., Ltd., Kanagawa (JP)

(21) Appl. No.: 19/018,799

(22) Filed: Jan. 13, 2025

(30) Foreign Application Priority Data
Mar. 15, 2024 (JP) 2024-040783

(51) Int. Cl. B60K 35/28; B60K 35/235

(52) U.S. Cl. CPC B60K 35/28; B60K 35/235; B60K 2360/178; B60K 2360/1868; B60K 2360/195; B60K 2360/785

(57) ABSTRACT

An information display method is implemented by using a head-up display device that displays information onto a windshield of a vehicle. The method includes detecting a position of a target object present outside the vehicle. The method includes calculating, based on an eye point of a driver, a field-of-view range defining a space where presence of the target object is visually recognizable by the driver. The method includes calculating, based on the eye point, a display range defining a space viewable by the driver through a range on the windshield in which the information is displayed. The method includes displaying target object information at a position corresponding to the target object when a position of the target object is outside the field-of-view range and inside the display range. The method includes hiding the target object information when the position of the target object is inside the field-of-view range.

### CROSS-REFERENCE TO RELATED APPLICATIONS

This application is based upon and claims the benefit of priority from Japanese Patent Application No. 2024-040783, filed on Mar. 15, 2024, the entire contents of which are incorporated herein by reference.

### FIELD

Embodiments described herein relate generally to an information display method, an information processing device, and a recording medium.

### BACKGROUND

A vehicle including a head-up display device that projects information on a windshield is known. For example, a patent literature JP 2021-049968 A discloses a head-up display device that displays an alert content for notifying of the presence of a pedestrian or the like.

Meanwhile, when the alert content is displayed in a superimposed manner on a target object that is already in a field of view, a driver feels uncomfortable because additional information is displayed even though the driver has already recognized the target object.

On the other hand, if the alert content is hidden (namely, is not displayed) for the already recognized target object, the alert content is not displayed on the target object in a superimposed manner even when the field of view changes due to a speed of the vehicle or the like and the target object is out of the field of view.

Therefore, there is a need for appropriately suggesting, to the driver, target object information that indicates the presence of a target object.

### SUMMARY

An information display method according to one aspect of the present disclosure is implemented by using a head-up display device serving to display information onto a windshield of a vehicle. The method includes detecting a position of a target object present outside the vehicle. The method includes calculating a field-of-view range based on an eye point of a driver who drives the vehicle. The field-of-view range defines a space where presence of the target object is visually recognizable by the driver. The method includes calculating a display range based on the eye point. The display range defines a space viewable by the driver through a range on the windshield in which the information is displayed by the head-up display device. The method includes causing the head-up display device to display target object information at a position corresponding to the target object in a case where a position of the target object is outside the field-of-view range and inside the display range. The method includes causing the head-up display device to hide the target object information in a case where the position of the target object is inside the field-of-view range.

### BRIEF DESCRIPTION OF THE DRAWINGS

FIG. 1 is a diagram illustrating a vehicle according to an embodiment;

FIG. 2 is a diagram schematically illustrating an example of a field-of-view range and a display range;

FIG. 3 is a diagram illustrating an example of a relationship between a speed of a vehicle and a viewing angle in a horizontal direction;

FIG. 4 is a diagram illustrating a functional configuration of an information processing device;

FIG. 5 is a flowchart illustrating a procedure of processing in the information processing device in a case where a target object is a person;

FIG. 6 is a diagram illustrating an example of an image displayed in a case where the target object is a person and a position of the target object is inside the field-of-view range and inside the display range;

FIG. 7 is a diagram illustrating an example of an image displayed in a case where the target object is a person and the position of the target object is inside the field-of-view range and outside the display range;

FIG. 8 is a diagram illustrating an example of an image displayed in a case where the target object is a person and the position of the target object is outside the field-of-view range and inside the display range;

FIG. 9 is a diagram illustrating an example of an image displayed in a case where target objects are persons and a position of each of the target objects is outside the field-of-view range and inside the display range;

FIG. 10 illustrates an example of an image displayed when the target object is a person, the position of the target object is outside the field-of-view range and outside the display range, and the speed of the vehicle is higher than a predetermined speed;

FIG. 11 illustrates an example of an image displayed in a case where the target object is a person, the position of the target object is outside the field-of-view range and outside the display range, and the speed of the vehicle is equal to or lower than the predetermined speed;

FIG. 12 is a diagram illustrating an example of an image in which warning information is displayed in each of a left space and a right space;

FIG. 13 is a diagram illustrating an example of an image in which alert information is displayed in the left space and the warning information is displayed in the right space;

FIG. 14 is a diagram illustrating an example of an image in which the alert information is displayed in each of the left space and the right space;

FIG. 15 is a diagram illustrating an example of the alert information in a case where a distance from the target object to the vehicle is equal to or larger than a predetermined distance;

FIG. 16 is a diagram illustrating an example of the alert information in a case where the distance from the target object to the vehicle is smaller than the predetermined distance;

FIG. 17 is a diagram illustrating an example of the warning information in which a display position and a shape are changed with time;

FIG. 18 is a flowchart illustrating a procedure of processing in the information processing device in a case where the target object is a preset facility or destination;

FIG. 19 is a diagram illustrating an example of an image displayed in a case where the target object is a gas station, which is an example of the preset facility, and the position of the target object is inside the field-of-view range and inside the display range;

FIG. 20 is a diagram illustrating an example of an image displayed in a case where the target object is a gas station and the position of the target object is inside the field-of-view range and outside the display range;

FIG. 21 is a diagram illustrating an example of an image displayed in a case where the target object is a gas station and the position of the target object is outside the field-of-view range and inside the display range;

FIG. 22 is a diagram illustrating an example of an image in a case where a gas station is present on a left-front side of the vehicle; and

FIG. 23 is a diagram illustrating an example of an image in a case where a gas station is present in front of the vehicle.

### DETAILED DESCRIPTION

Hereinafter, embodiments of the present disclosure will be described in detail with reference to the drawings as appropriate. However, unnecessarily detailed description may be omitted. Note that the accompanying drawings and the following description are provided for those skilled in the art to fully understand the present disclosure, and are not intended to limit the subject matter described in the claims.

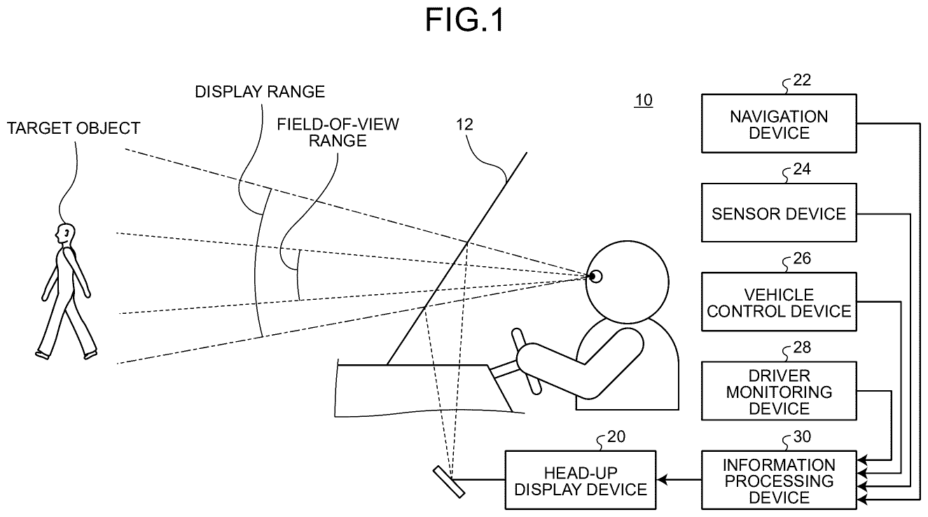

FIG. 1 is a diagram illustrating a vehicle 10 according to an embodiment.

The vehicle 10 according to the embodiment includes a head-up display device 20, a navigation device 22, a sensor device 24, a vehicle control device 26, a driver monitoring device 28, and an information processing device 30.

The head-up display device 20 displays information in a field of view of a driver who drives the vehicle 10 on a windshield 12. The head-up display device 20 projects information onto, for example, the windshield 12 of the vehicle 10. As a result, the driver is able to visually check the information displayed by the head-up display device 20 while visually checking a road, a traffic light, a person, or a facility outside the vehicle 10.

The navigation device 22 navigates a traveling route of the vehicle 10 based on map information. In one example, the navigation device 22 displays, on the monitor, image data in which a traveling route from a current position of the vehicle 10 to a destination is superimposed on a map, or provides voice guidance for the traveling route.

The sensor device 24 includes an imaging device that images the surroundings of the vehicle 10, and a sensor group used for detecting a position of a target object around the vehicle 10, such as a light detection and ranging (LIDAR) device.

The vehicle control device 26 includes an electronic control unit (ECU) to control traveling of the vehicle 10 and the like.

The driver monitoring device 28 images the driver to detect a viewpoint of the driver, a face orientation of the driver, a gaze direction of the driver, a state of the driver, etc., based on image data obtained by imaging the driver and driver information stored in advance for the driver.

The information processing device 30 generates image data to be displayed by the head-up display device 20 and causes the head-up display device 20 to display the generated image data. The information processing device 30 acquires information and a signal each sent from the navigation device 22, the sensor device 24, the vehicle control device 26, the driver monitoring device 28, or the like, and generates the image data to be displayed by the head-up display device 20. The information processing device 30 includes a central processing unit (CPU), a read only memory (ROM), a random access memory (RAM), and the like. The CPU executes information processing by executing a computer program stored in the ROM, thereby implementing each function of the information processing device 30.

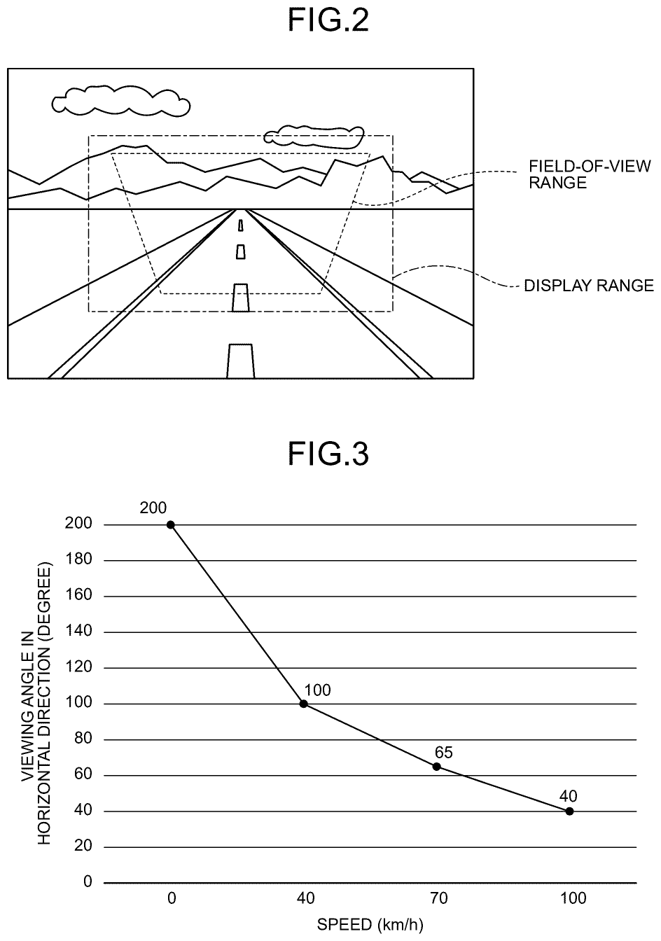

FIG. 2 is a diagram schematically illustrating an example of a field-of-view range and a display range.

In the present embodiment, the field-of-view range defines a space where the presence of the target object is visually recognizable by the driver. Additionally, the display range defines a space that is viewable by the driver through a range in which information is displayed by the head-up display device 20 onto the windshield 12. Such a field-of-view range changes with an eye point and the gaze direction of the driver. In a case where the range in which information is displayed by the head-up display device 20 onto the windshield 12 has been fixed, the display range changes with the eye point and the gaze direction of the driver.

FIG. 3 is a diagram illustrating an example of a relationship between a speed of the vehicle 10 and a viewing angle in a horizontal direction.

In general, the higher the speed of the vehicle 10, the smaller the viewing angle of a human. For example, as illustrated in FIG. 3, in a case where the speed of the vehicle 10 is 0, namely, the vehicle is stopped, the viewing angle in the horizontal direction is about 200 degrees, whereas the viewing angle in the horizontal direction is narrowed to about 40 degrees in a case where the speed is about 100 km/h. Therefore, the field-of-view range changes with the eye point and the gaze direction of the driver, and also changes with the speed of the vehicle 10.

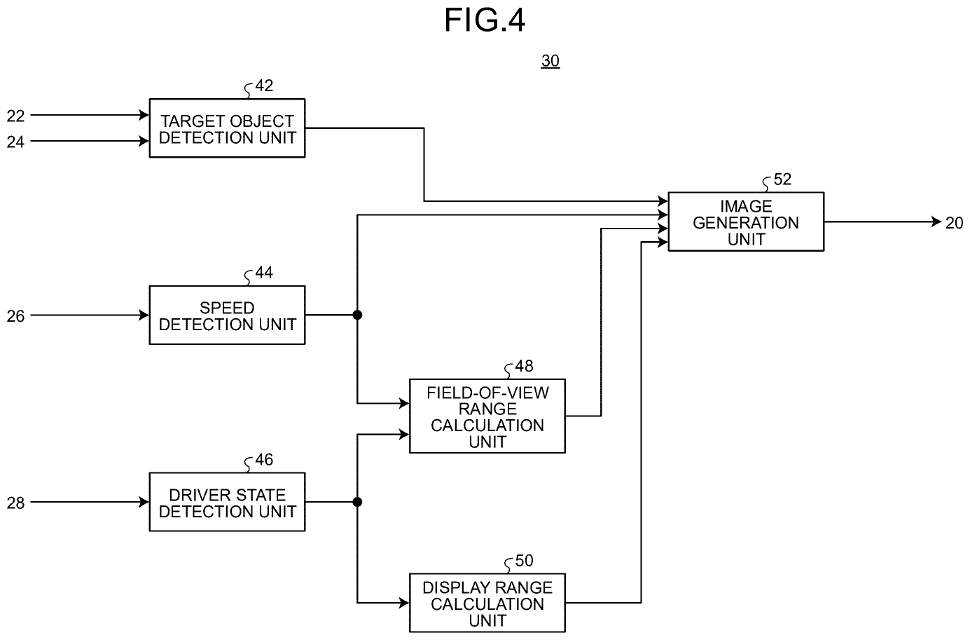

FIG. 4 is a diagram illustrating a functional configuration of the information processing device 30.

The information processing device 30 includes a target object detection unit 42, a speed detection unit 44, a driver state detection unit 46, a field-of-view range calculation unit 48, a display range calculation unit 50, and an image generation unit 52.

The target object detection unit 42 detects a position of the target object based on data detected by the navigation device 22 and data detected by the sensor device 24. Specifically, the target object detection unit 42 detects a relative position of the target object with respect to the position of the vehicle 10.

In one example, the target object is a person. In this case, the target object detection unit 42 detects a person included in image data by performing image analysis of the image data detected by the sensor device 24. Then, the target object detection unit 42 detects a three-dimensional position of the detected person.

The target object may be a preset facility or a preset destination. The facility may be a building or a shop designated by the driver. The destination may be a facility, an address, or the latitude and longitude, each designated by the driver. In this case, the target object detection unit 42 detects the position of the target object based on coordinates of the vehicle 10 obtained from the navigation device 22 and coordinates of the target object obtained from the map information.

The speed detection unit 44 detects the speed of the vehicle 10. In one example, the speed detection unit 44 acquires speed data detected by the vehicle control device 26.

The driver state detection unit 46 detects the eye point and the gaze direction of the driver based on the information detected by the driver monitoring device 28.

The field-of-view range calculation unit 48 calculates the field-of-view range based on the eye point and the gaze direction detected by the driver state detection unit 46 and the speed detected by the speed detection unit 44. In one example, the field-of-view range calculation unit 48 calculates a standard field-of-view range based on the eye point and the gaze direction, and then changes the field-of-view range in accordance with the speed of the vehicle 10. The field-of-view range calculation unit 48 stores in advance, for example, a table or the like indicating a correspondence between the speed of the vehicle 10 and the viewing angle. The field-of-view range calculation unit 48 changes, based on the table, the field-of-view range in accordance with the speed. In one example, the field-of-view range calculation unit 48 changes the field-of-view range such that the higher the speed, the narrower the field-of-view range.

The display range calculation unit 50 calculates the display range based on information, such as the eye point and the gaze direction detected by the driver state detection unit 46, a display setting of the head-up display device 20, etc.

The image generation unit 52 acquires the position of the target object detected by the target object detection unit 42, the speed of the vehicle 10 detected by the speed detection unit 44, the field-of-view range calculated by the field-of-view range calculation unit 48, and the display range calculated by the display range calculation unit 50. The image generation unit 52 generates target object information to be displayed by the head-up display device 20 based on the position of the target object, the speed, the field-of-view range, and the display range. The image generation unit 52 generates image data including the target object information. The image generation unit 52 supplies the generated image data to the head-up display device 20, and causes the head-up display device 20 to project the image data onto the windshield 12.

In a case where the target object is a person, the target object information is warning information for warning the driver that a person is present, or is alert information for alerting the driver to the presence of a person. The target object information is notification information for notifying the driver that the target object is present in a case where the target object is a facility or destination.

In a case where the position of the target object is outside the field-of-view range and inside the display range, the image generation unit 52 causes the head-up display device 20 to display the target object information at a position corresponding to the target object on the windshield 12. In a case where the position of the target object is inside the field-of-view range, the image generation unit 52 causes the head-up display device 20 to hide (namely, not to display) the target object information.

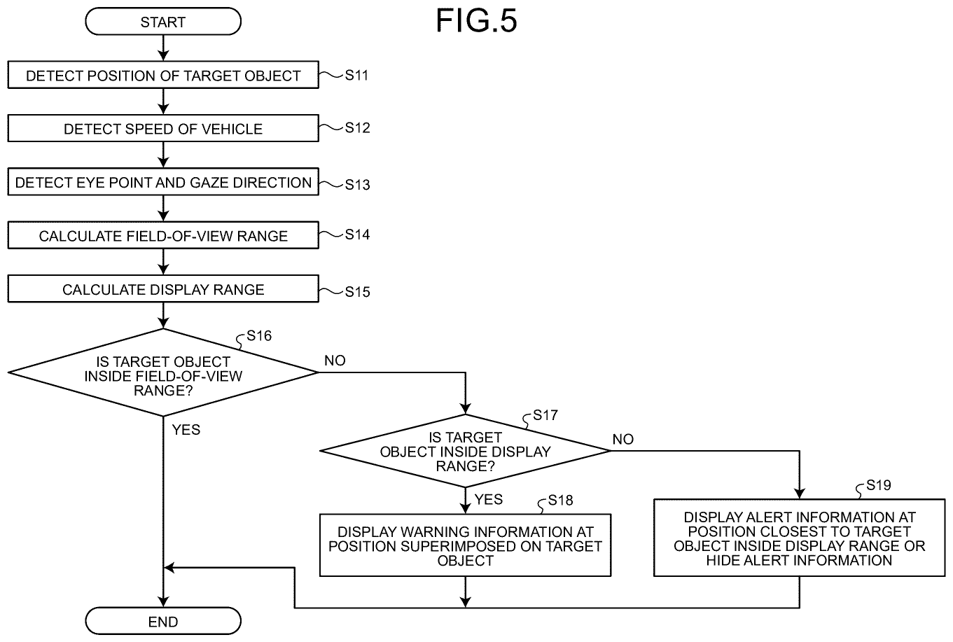

FIG. 5 is a flowchart illustrating a procedure of processing in the information processing device 30 in a case where the target object is a person.

In a case where the target object is a person, the information processing device 30 executes processing in the procedure illustrated in FIG. 5 at regular time intervals, for example.

First, in S11, the information processing device 30 detects the position of the target object. In S12, the information processing device 30 detects the speed of the vehicle 10. In S13, the information processing device 30 detects the eye point and the gaze direction of the driver. In S14, the information processing device 30 calculates the field-of-view range. In S15, the information processing device 30 calculates the display range.

Subsequently, in S16, the information processing device 30 determines whether or not the position of the target object is inside the field-of-view range.

In response to determining that the position of the target object is inside the field-of-view range (Yes in S16), the information processing device 30 ends this procedure without displaying any target object. In other words, in a case where the position of the target object is inside the field-of-view range (Yes in S16), the information processing device 30 causes the head-up display device 20 to hide the target object information. With this processing, the information processing device 30 does not display the target object information for the target object which is already recognized by the driver and whose position is inside the field-of-view range. Therefore, it is possible to eliminate discomfort felt by the driver.

In response to determining that the position of the target object is not inside the field-of-view range, namely, the position of the target object is outside the field-of-view range (No in S16), the information processing device 30 advances the processing to S17.

In S17, the information processing device 30 determines whether or not the position of the target object is inside the display range. In response to determining that the position of the target object is inside the display range (Yes in S17), the information processing device 30 advances the processing to S18. In response to determining that the position of the target object is not inside the display range, namely, the position of the target object is outside the display range (No in S17), the information processing device 30 advances the processing to S19.

In S18, the information processing device 30 causes the head-up display device 20 to display, as the target object information, the warning information for warning the driver that the target object is present at the position corresponding to the target object. In the present embodiment, the information processing device 30 causes the head-up display device 20 to display the warning information at a position superimposed on the target object.

By executing the processing of S18, the information processing device 30 can cause the head-up display device 20 to display the warning information at the position superimposed on the target object in a case where the position of the target object is outside the field-of-view range and inside the display range. As a result, the information processing device 30 can warn the driver that a person who is not visually recognized by the driver is present inside the display range. When the processing of S18 is completed, the information processing device 30 ends this procedure.

In S19, the information processing device 30 causes the head-up display device 20 to display, as the target object information, the alert information for alerting the driver to the presence of the target object at a position closest to the target object inside the display range.

By executing the processing of S19, the information processing device 30 can causes the head-up display device 20 to display the alert information at the position closest to the target object inside the display range in a case where the position of the target object is outside the field-of-view range and outside the display range. As a result, the information processing device 30 can alert the driver to the presence of a person who is not visually recognized by the driver outside the display range.

Note that, in S19, the information processing device 30 may change a display format of the alert information in accordance with the speed of the vehicle 10. In one example, in a case where the speed of the vehicle 10 is 0, namely, the vehicle 10 is stopped, the information processing device 30 causes the head-up display device 20 to hide the alert information. With this processing, the information processing device 30 does not alert the driver when the vehicle 10 is stopped and thus the vehicle 10 does not collide with the target object. Therefore, the discomfort felt by the driver can be eliminated.

Alternatively, the information processing device 30 may use, as the display format of the alert information, a format by which the higher the speed of the vehicle 10, the more emphasized the alert information. As a result, the information processing device 30 can more strongly alert the driver to the presence of the target object as the speed of the vehicle 10 is higher.

Alternatively, in S19, the information processing device 30 may change the display format of the alert information in accordance with a distance from the target object to the vehicle 10. In one example, the information processing device 30 causes the head-up display device 20 to hide the alert information in a case where the distance from the target object to the vehicle 10 is equal to or larger than a preset distance. With this processing, since the information processing device 30 does not alert the driver to the presence of the target object that is located sufficiently far from the vehicle 10, it is possible to eliminate the discomfort felt by the driver.

Alternatively, the information processing device 30 may use, as the display format of the alert information, a format by which the closer the target object to the vehicle 10, the more emphasized the alert information. With this processing, the information processing device 30 can more strongly alert the driver to the presence of the target object as the target object is closer to the vehicle 10.

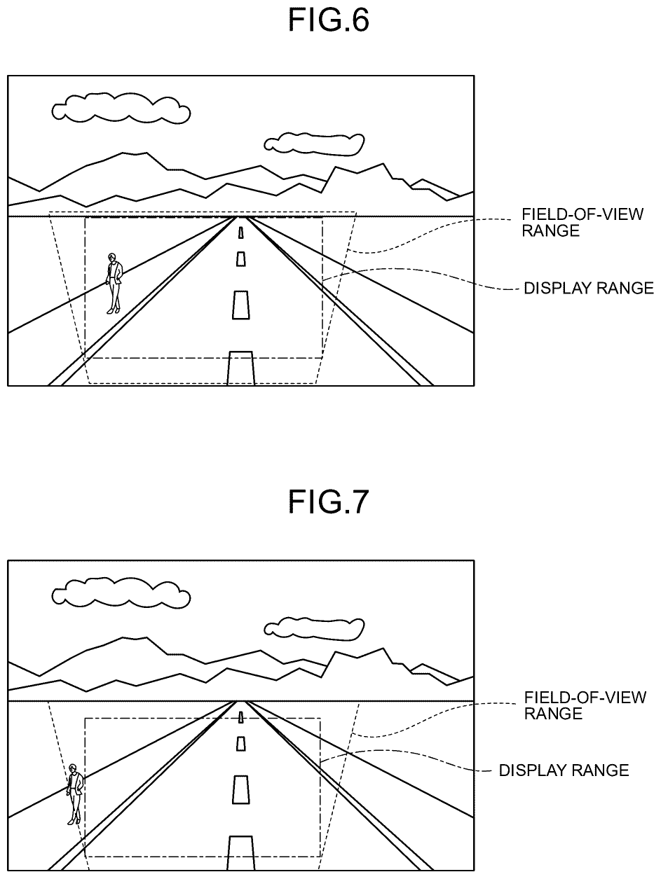

FIG. 6 is a diagram illustrating an example of an image displayed in a case where the target object is a person and the position of the target object is inside the field-of-view range and inside the display range.

In a case where the target object is a person and the position of the target object is inside the field-of-view range and inside the display range, the information processing device 30 causes the head-up display device 20 to hide the warning information and the alert information as illustrated in FIG. 6. With this processing, since the warning information and the alert information are not displayed for the target object already recognized by the driver, it is possible to eliminate the discomfort felt by the driver.

FIG. 7 is a diagram illustrating an example of an image displayed in a case where the target object is a person and the position of the target object is inside the field-of-view range and outside the display range.

In a case where the target object is a person and the position of the target object is inside the field-of-view range and outside the display range, the information processing device 30 causes the head-up display device 20 to hide the warning information and the alert information as illustrated in FIG. 7. With this processing, the warning information and the alert information are not displayed for the target object already recognized by the driver, so that it is possible to eliminate the discomfort felt by the driver.

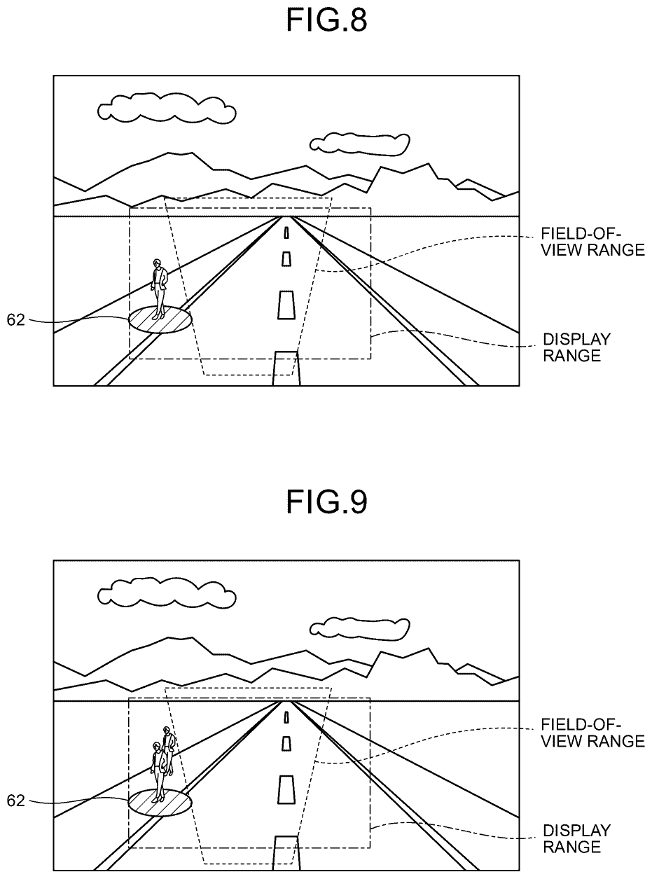

FIG. 8 is a diagram illustrating an example of an image displayed in a case where the target object is a person and the position of the target object is outside the field-of-view range and inside the display range.

In a case where the target object is a person and the position of the target object is outside the field-of-view range and inside the display range, the information processing device 30 causes the head-up display device 20 to display the warning information at a position superimposed on the target object as illustrated in FIG. 8. In the example of FIG. 8, first warning information 62, which is elliptical warning information, is displayed so as to be superimposed on part of a lower side of the person. With this processing, the information processing device 30 can notify the driver that a person who is not visually recognized by the driver is present inside the display range.

FIG. 9 is a diagram illustrating an example of an image displayed in a case where the target object is a person and a position of each of target objects is outside the field-of-view range and inside the display range.

In a case where the target object is a person and the position of each of the target objects is outside the field-of-view range and inside the display range, the information processing device 30 causes the head-up display device 20 to display the warning information at a position superimposed on the target object closest to the vehicle 10 among the target objects as illustrated in FIG. 9. In the example of FIG. 9, the first warning information 62 is displayed so as to be superimposed on part of a lower side of a person closest to the vehicle 10 out of the two persons. With this processing, the information processing device 30 can notify the driver of a position of a person to be paid attention to the most among persons who are not visually recognized by the driver, inside the display range.

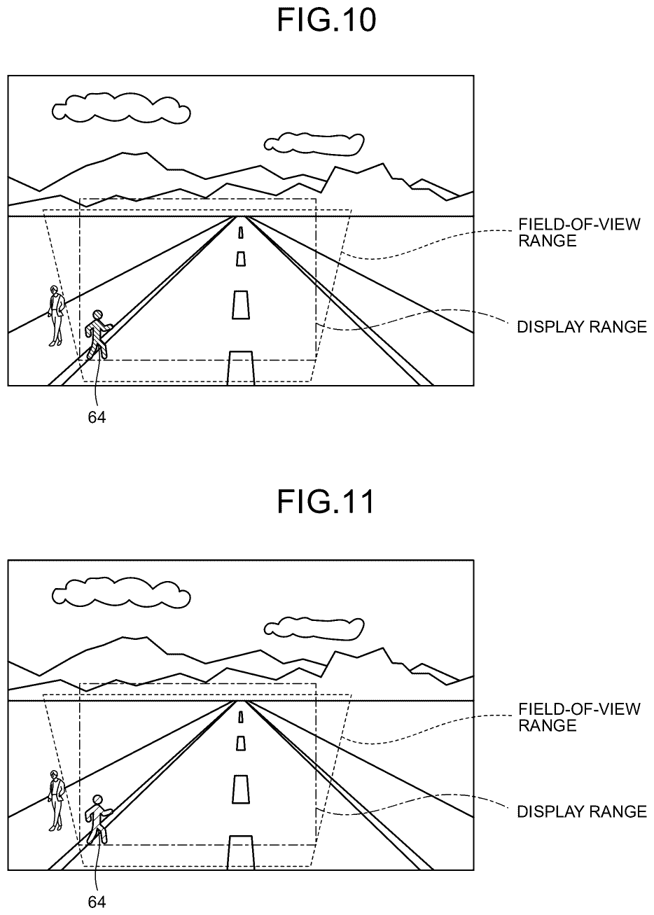

FIGS. 10 and 11 are diagrams illustrating an example of an image displayed in a case where the target object is a person and the position of the target object is outside the field-of-view range and outside the display range.

In FIG. 10, an example of an image is illustrated, which is displayed in a case where the speed of the vehicle 10 is higher than a predetermined speed or the distance from the target object to the vehicle 10 is smaller than a predetermined distance. In FIG. 11, an example of an image is illustrated, which is displayed in a case where the speed of the vehicle 10 is equal to or lower than the predetermined speed or the distance from the target object to the vehicle 10 is equal to or larger than the predetermined distance.

In a case where the target object is a person and the position of the target object is outside the field-of-view range and outside the display range, the information processing device 30 causes the head-up display device 20 to display the alert information at a position closest to the target object inside the display range, namely, at a position in a direction of the target object near an outer boundary of the display range inside the display range as illustrated in FIGS. 10 and 11. In the examples of FIGS. 10 and 11, first alert information 64, which is a human-shaped icon, is displayed. With this processing, the information processing device 30 can notify the driver that there is a person who is not visually recognized by the driver outside the display range. Additionally, since the alert information is displayed at a position closest to the target object inside the display range, the direction of the target object can be shown to the driver.

The information processing device 30 may change the display format of the alert information in accordance with the speed of the vehicle 10. In one example, the information processing device 30 may use, as the display format of the alert information, a format by which the higher the speed of the vehicle 10, the more emphasized the alert information. As illustrated in FIG. 10, the information processing device 30 increases intensity of the alert information or displays the alert information in a warm color such as red as the speed of the vehicle 10 increases. Alternatively, the information processing device 30 may decrease the intensity of the alert information or increase a component of a color of a cool color system, such as blue, as the speed of the vehicle 10 decreases. With this processing, the information processing device 30 can more strongly alert the driver to the presence of the target object as the speed of the vehicle 10 is higher.

The information processing device 30 may change the display format of the alert information in accordance with the distance from the target object to the vehicle 10. The information processing device 30 may use, as the display format of the alert information, a format by which the closer the target object to the vehicle 10, the more emphasized the alert information. In one example, as illustrated in FIG. 10, the information processing device 30 increases the intensity of the alert information or displays the alert information in a warm color, such as red, as the target object is closer to the vehicle 10. Alternatively, as illustrated in FIG. 11, the information processing device 30 may decrease the intensity of the alert information or increase a component of a cool color in the alert information, such as blue, as the target object becomes farther from the vehicle 10. With this processing, the information processing device 30 can more strongly alert the driver to the presence of the target object as the target object is closer to the vehicle 10.

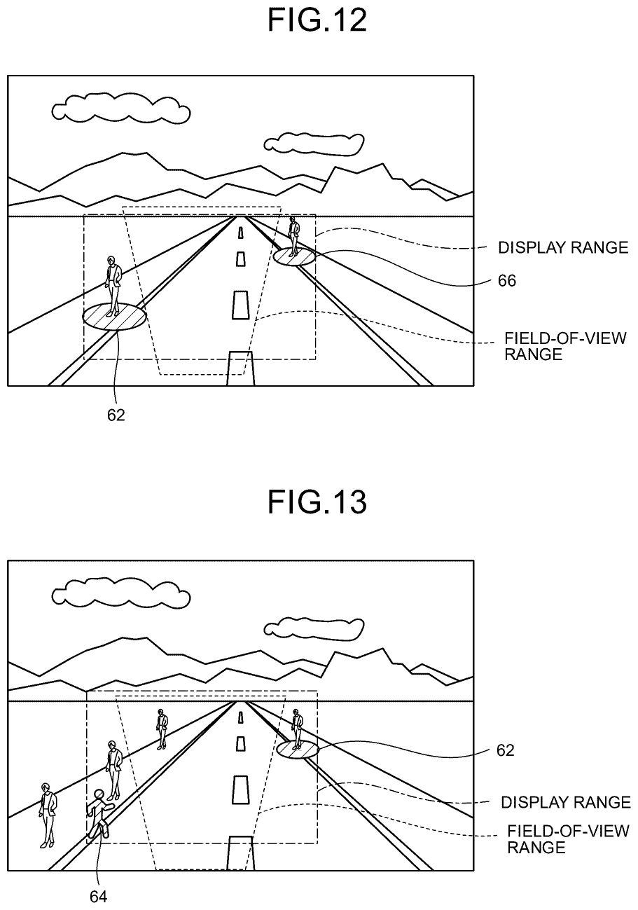

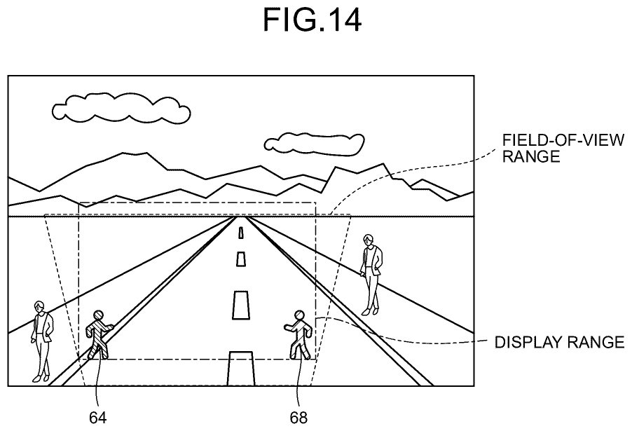

FIGS. 12, 13, and 14 are diagrams illustrating examples of images displayed in a case where separation into a left space and a right space is made. FIG. 12 is a diagram illustrating an example of an image in which the warning information is displayed in each of the left space and the right space. FIG. 13 is a diagram illustrating an example of an image in which the alert information is displayed in the left space and the warning information is displayed in the right space. FIG. 14 is a diagram illustrating an example of an image in which the alert information is displayed in each of the left space and the right space.

The information processing device 30 may separate the left space and the right space with respect to a traveling direction of the vehicle 10, and display the warning information or alert information about the target object closest to the vehicle 10 in the left space and the warning information or alert information about the target object closest to the vehicle 10 in the right space. With this processing, the information processing device 30 can notify the driver of the target object to be paid attention to the most for each of the left space and the right space.

In one example, in a case where the positions of the target objects closest to the vehicle 10 in the left space and the right space are both outside the field-of-view range and inside the display range, the information processing device 30 causes the head-up display device 20 to display the warning information by superimposing the warning information onto each target object. In the example of FIG. 12, the first warning information 62 is displayed so as to be superimposed on part of the lower side of the person closest to the vehicle 10 in the left space, and second warning information 66, which is elliptical warning information, is displayed so as to be superimposed on part of the lower side of the person closest to the vehicle 10 in the right space.

In one example, in a case where the position of the target object closest to the vehicle 10 in a first space, which is one of the left space and the right space, is outside the field-of-view range and inside the display range, the information processing device 30 causes the head-up display device 20 to display the warning information so as to be superimposed on the target object. Moreover, in a case where the position of the target object closest to the vehicle 10 in a second space, which is different from the first space and is the other one of the left space and the right space, is outside the field-of-view range and outside the display range, the alert information is displayed at a position closest to the target object inside the display range. In the example of FIG. 13, the first alert information 64 is displayed at a position closest to a person closest to the vehicle 10 in the left space inside the display range. In addition, the first warning information 62 is displayed at a position superimposed on a person closest to the vehicle 10 in the right space inside the display range.

In one example, in a case where the positions of the target objects closest to the vehicle 10 in the left space and the right space are both outside the field-of-view range and outside the display range, the information processing device 30 causes the head-up display device 20 to display the alert information at the closest position inside the display range for each target object. In the example of FIG. 14, the first alert information 64 is displayed at a position closest to the person closest to the vehicle 10 in the left space inside the display range. In addition, second alert information 68, which is the alert information of a human-shaped icon, is displayed at a position closest to the person closest to the vehicle 10 in the right space inside the display range.

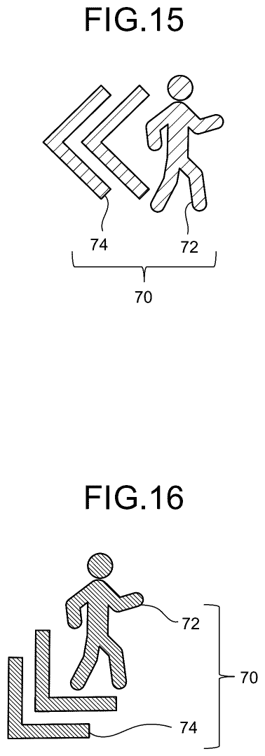

FIG. 15 is a diagram illustrating an example of the alert information in a case where the distance from the target object to the vehicle 10 is equal to or larger than the predetermined distance. FIG. 16 is a diagram illustrating an example of the alert information in a case where the distance from the target object to the vehicle 10 is smaller than the predetermined distance.

The information processing device 30 may calculate a direction from the vehicle 10 toward the target object and include, in the alert information, direction information indicating the calculated direction. With this processing, the information processing device 30 can notify the driver of a direction in which the target object to be paid attention to is present.

Specifically, for example, third alert information 70 in FIGS. 15 and 16 includes a human-shaped icon 72 and a direction icon 74. In a case where such third alert information 70 is displayed, the information processing device 30 generates a direction indicated by the direction icon 74 so as to match the direction from the vehicle 10 toward the target object. With this processing, the information processing device 30 can clearly notify the driver of a direction in which the target object to be paid attention to is present.

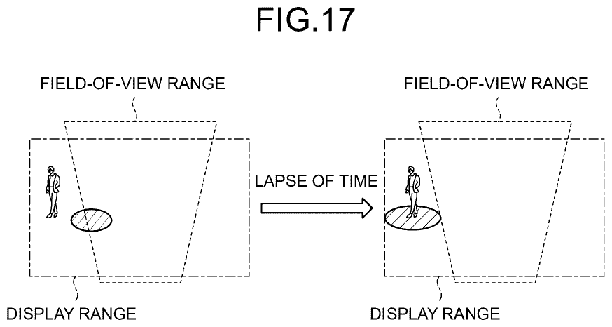

FIG. 17 is a diagram illustrating an example of the warning information in which a display position and a shape are changed with time.

The information processing device 30 may change a position of the warning information in accordance with the lapse of time. In one example, the information processing device 30 causes the head-up display device 20 to display the warning information at a position closest to the target object inside the display range at a first time (t₁). Subsequently, the information processing device 30 causes the head-up display device 20 to move the display position of the warning information in the direction of the target object in accordance with the lapse of time. Then, the information processing device 30 displays the warning information so as to be superimposed on the target object at a second time (t₂).

Moreover, the information processing device 30 causes the head-up display device 20 to display the warning information in the smallest shape at the first time (t₁) and display the warning information in the largest shape at the second time (t₂) while increasing the shape of the warning information with the lapse of time.

By displaying the warning information in this manner, the information processing device 30 can guide a gaze of the driver from the inside to the outside of the field-of-view range. As a result, the information processing device 30 can cause the driver to recognize the warning information more reliably. Additionally, the information processing device 30 may repeatedly execute such change processing for the position of the warning information in accordance with the lapse of time.

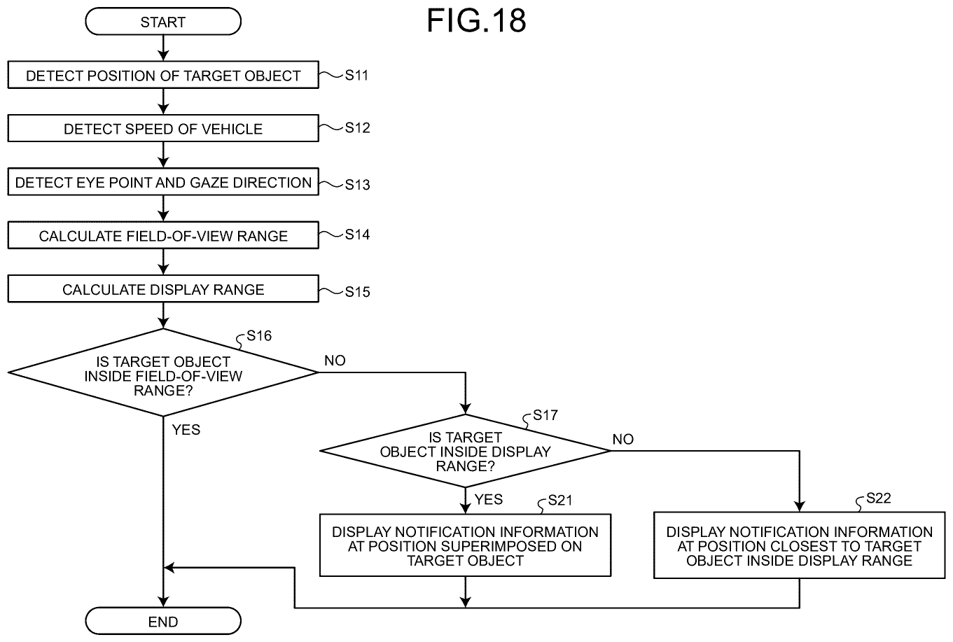

FIG. 18 is a flowchart illustrating a procedure of processing in the information processing device 30 in a case where the target object is a preset facility or destination.

In a case where the target object is a facility or destination, the information processing device 30 executes processing in accordance with the procedure illustrated in FIG. 18 at regular time intervals. In the processing of FIG. 18, processing from S11 to S17 is the same as processing of FIG. 5, and processing after S17 is different. Therefore, in the flowchart of FIG. 18, a description of the processing from S11 to S16 is omitted, and the processing from S17 will be described.

In S17, the information processing device 30 determines whether or not the position of the target object is inside the display range. In response to determining that the position of the target object is inside the display range (Yes in S17), the information processing device 30 advances the processing to S21. In response to determining that the position of the target object is not inside the display range, namely, the position of the target object is outside the display range (No in S17), the information processing device 30 advances the processing to S22.

In S21, the information processing device 30 causes the head-up display device 20 to display, as the target object information, the notification information for notifying the driver that the target object is present at a position corresponding to the target object. In the present embodiment, the information processing device 30 causes the head-up display device 20 to display the notification information at a position superimposed on the target object.

By executing the processing of S21, the information processing device 30 can display the notification information at the position superimposed on the target object in a case where the position of the target object is outside the field-of-view range and inside the display range. As a result, the information processing device 30 can notify the driver that a facility or destination which is not visually recognized by the driver is present inside the display range. Once the processing of S21 is completed, the information processing device 30 ends this procedure.

In S22, the information processing device 30 causes the head-up display device 20 to display, as the target object information, the notification information at a position closest to the target object inside the display range.

By executing the processing of S22, the information processing device 30 can display the notification information at the position closest to the target object inside the display range in a case where the position of the target object is outside the field-of-view range and outside the display range. As a result, the information processing device 30 can notify the driver that a facility or destination which is not visually recognized by the driver is present outside the display range.

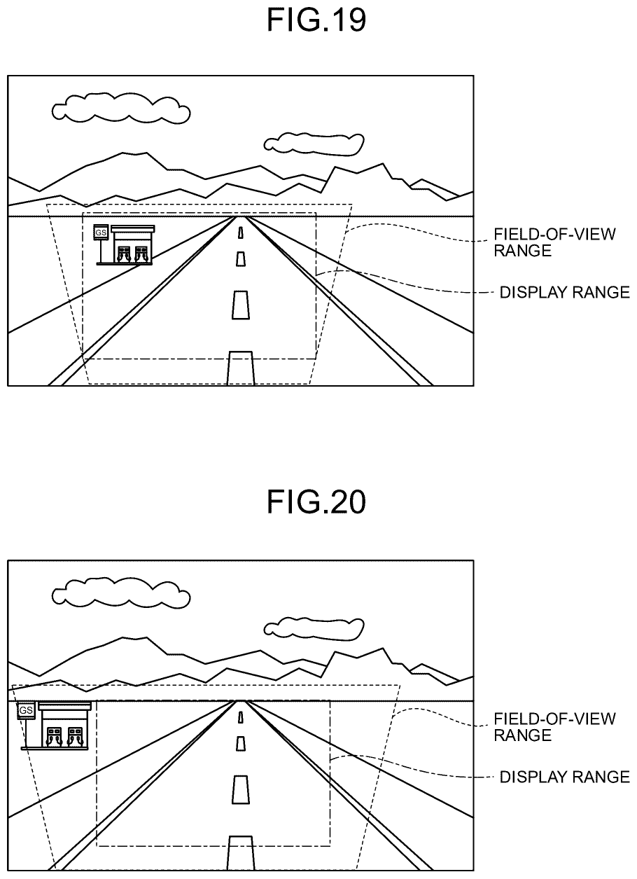

FIG. 19 is a diagram illustrating an example of an image displayed in a case where the target object is a gas station which is an example of the preset facility, and the position of the target object is inside the field-of-view range and inside the display range.

In a case where the target object is a gas station and the position of the target object is inside the field-of-view range and inside the display range, the information processing device 30 causes the head-up display device 20 to hide (namely, not to display) the notification information as illustrated in FIG. 19. As a result, the information processing device 30 does not display the notification information for the target object already recognized by the driver, so that it is possible to eliminate the discomfort felt by the driver.

FIG. 20 is a diagram illustrating an example of an image displayed in a case where the target object is a gas station and the position of the target object is inside the field-of-view range and outside the display range.

In a case where the target object is a gas station and the position of the target object is inside the field-of-view range and outside the display range, the information processing device 30 causes the head-up display device 20 to hide the notification information as illustrated in FIG. 20. As a result, the information processing device 30 does not display the notification information for the target object already recognized by the driver, so that it is possible to eliminate the discomfort felt by the driver.

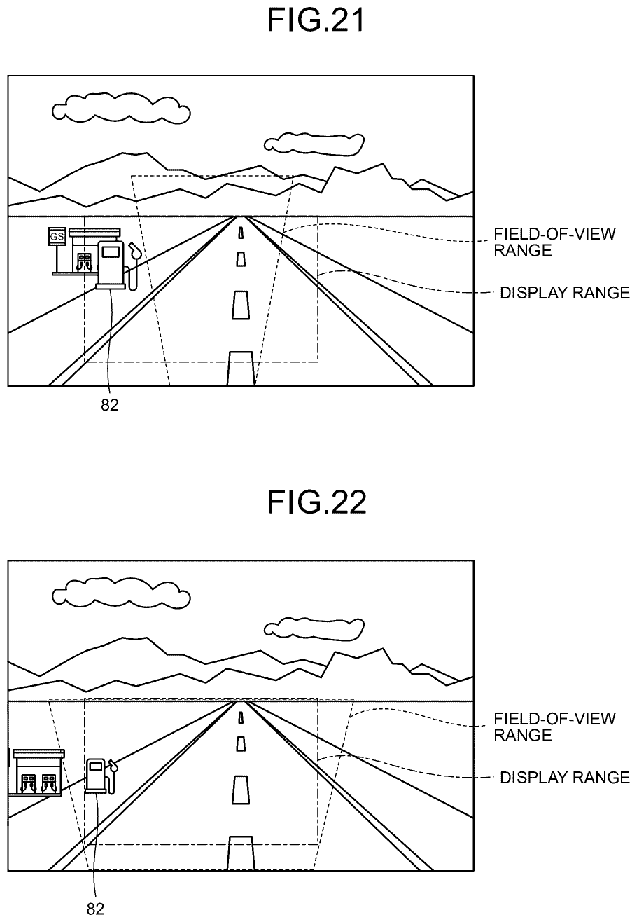

FIG. 21 is a diagram illustrating an example of an image displayed in a case where the target object is a gas station and the position of the target object is outside the field-of-view range and inside the display range.

In a case where the target object is a gas station and the position of the target object is outside the field-of-view range and inside the display range, the information processing device 30 causes the head-up display device 20 to display the notification information at a position superimposed on the target object as illustrated in FIG. 21. In the example of FIG. 21, first notification information 82, which is an icon representing a gas station, is displayed so as to be superimposed on part of the gas station. As a result, the information processing device 30 can notify the driver that a gas station that is not visually recognized by the driver is present inside the display range.

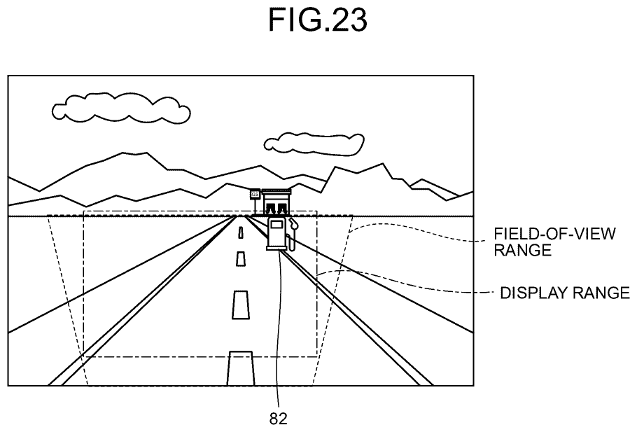

FIGS. 22 and 23 are diagrams illustrating examples of images displayed in a case where the target object is a gas station and the position of the target object is outside the field-of-view range and outside the display range.

FIG. 22 is a diagram illustrating an example of an image in a case where a gas station is present on a left-front side of the vehicle 10. FIG. 23 is a diagram illustrating an example of an image in a case where a gas station is present on a right-front side of the vehicle 10.

In a case where the target object is a gas station and the position of the target object is outside the field-of-view range and outside the display range, the information processing device 30 causes the head-up display device 20 to display the notification information at a position closest to the target object inside the display range, namely, at a position in the direction of the target object near the outer boundary of the display range inside the display range as illustrated in FIGS. 22 and 23. In the examples of FIGS. 22 and 23, the first notification information 82 is displayed. As a result, the information processing device 30 can notify the driver that there is a gas station that is not visually recognized by the driver outside the display range. Additionally, since the notification information is displayed at a position closest to the target object inside the display range, the driver can also be notified of the direction of the target object.

As described above, the information processing device 30 according to the present embodiment causes the head-up display device 20 to display the target object information at a position corresponding to the target object in a case where the position of the target object is outside the field-of-view range and inside the display range, and causes the head-up display device 20 to hide (namely, not to display) the target object information in a case where the position of the target object is inside the field-of-view range. Thus, the target object information about the target object that is already visually recognized by the driver is not displayed, whereas the target object information about the target object information that is not visually recognized by the driver is displayed. With this configuration, the information processing device 30 can eliminate the discomfort felt by the driver, and can cause the driver to reliably recognize the target object to be warned, paid attention to, and notified. Therefore, with the information processing device 30 according to the present embodiment, the head-up display device 20 can appropriately present the target object information indicating the presence of the target object to the driver.

In the embodiment, an example in which the driver state detection unit 46 detects the eye point and the gaze direction of the driver based on the information detected by the driver monitoring device 28 has been described, but the present disclosure is not limited to this example. The field-of-view range calculation unit 48 and the display range calculation unit 50 may have information of the eye point and the gaze direction of the driver in advance, and calculate the field-of-view range and the display range based on the information. As an example, the field-of-view range calculation unit 48 and the display range calculation unit 50 may have average information of the eye point and the gaze direction of the driver calculated in advance as the information of the eye point and the gaze direction of the driver. In this case, the vehicle 10 does not have to include the driver monitoring device 28. Moreover, in this case, the information processing device 30 does not have to include the driver state detection unit 46.

A computer program for implementing processing executed by the information processing device 30 may be stored as a file in an installable format or an executable format in a non-transitory computer-readable recording medium such as a CD-ROM, a CD-R, a memory card, a digital versatile disk (DVD), or a flexible disk (FD) and provided as a computer program product. The program executed by the information processing device 30 according to the present embodiment may be stored on a computer connected to a network such as the Internet and be provided by being downloaded via the network. The program for implementing information processing executed by the information processing device 30 may be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information display method implemented by using a head-up display device serving to display information onto a windshield of a vehicle, the information display method comprising:
detecting a position of a target object present outside the vehicle;
calculating a field-of-view range based on an eye point of a driver who drives the vehicle, the field-of-view range defining a space where presence of the target object is visually recognizable by the driver;
calculating a display range based on the eye point, the display range defining a space viewable by the driver through a range on the windshield in which the information is displayed by the head-up display device;
causing the head-up display device to display target object information at a position corresponding to the target object in a case where a position of the target object is outside the field-of-view range and inside the display range; and
causing the head-up display device to hide the target object information in a case where the position of the target object is inside the field-of-view range.

2. The information display method according to claim 1, further comprising detecting the eye point of the driver who drives the vehicle.

3. The information display method according to claim 1, further comprising calculating the field-of-view range based on the eye point and a speed of the vehicle.

4. The information display method according to claim 1, further comprising, in a case where the position of the target object is outside the field-of-view range and inside the display range, causing the head-up display device to display, as the target object information, warning information for warning the driver that the target object is present at a position superimposed on the target object.

5. The information display method according to claim 1, further comprising, in a case where the position of the target object is outside the field-of-view range and outside the display range, causing the head-up display device to display, as the target object information, alert information for alerting the driver to the presence of the target object at a position closest to the target object inside the display range.

6. The information display method according to claim 5, further comprising changing a display format of the alert information in accordance with a distance from the target object to the vehicle.

7. The information display method according to claim 5, further comprising changing a display format of the alert information in accordance with a speed of the vehicle.

8. The information display method according to claim 5, further comprising including, in the alert information, direction information indicating a direction from the vehicle toward the target object.

9. The information display method according to claim 1, further comprising:
separating a left space and a right space with respect to a traveling direction of the vehicle; and
causing the head-up display device to display the target object information about the target object closest to the vehicle in the left space and the target object information about the target object closest to the vehicle in the right space.

10. The information display method according to claim 1, further comprising detecting the position of the target object based on information detected by a sensor device serving to detect the position of the target object present around the vehicle.

11. The information display method according to claim 1, wherein the target object is a person.

12. The information display method according to claim 1, further comprising, in a case where the position of the target object is outside the field-of-view range and inside the display range, causing the head-up display device to display, as the target object information, notification information for notifying the driver that the target object is present at a position superimposed on the target object.

13. The information display method according to claim 12, further comprising, in a case where the position of the target object is outside the field-of-view range and outside the display range, causing the head-up display device to display the notification information at a position closest to the target object inside the display range.

14. The information display method according to claim 12, further comprising calculating the position of the target object to be displayed by the head-up display device, based on coordinates of the target object detected by a navigation device serving to navigate a traveling route of the vehicle based on map information.

15. The information display method according to claim 12, wherein the target object is a preset facility or a preset destination.

16. An information processing device generating information to be displayed by a head-up display device serving to display information onto a windshield of a vehicle, the information processing device comprising:
a memory in which a computer program is stored; and
a processor coupled to the memory and configured to perform processing by executing the computer program, the processing including:
detecting a position of a target object present outside the vehicle;
calculating a field-of-view range based on an eye point of a driver who drives the vehicle, the field-of-view range defining a space where presence of the target object is visually recognizable by the driver;
calculating a display range based on the eye point, the display range defining a space viewable by the driver through a range on the windshield in which the information is displayed by the head-up display device;
causing the head-up display device to display target object information at a position corresponding to the target object in a case where a position of the target object is outside the field-of-view range and inside the display range; and
causing the head-up display device to hide the target object information in a case where the position of the target object is inside the field-of-view range.

17. A non-transitory computer-readable recording medium on which programmed instructions are recorded, the programmed instructions causing a computer to execute processing, the computer being caused, by the programmed instructions, to generate information to be displayed by a head-up display device serving to display information onto a windshield of a vehicle, the processing comprising:
detecting a position of a target object present outside the vehicle;
calculating a field-of-view range based on an eye point of a driver who drives the vehicle, the field-of-view range defining a space where presence of the target object is visually recognizable by the driver;
calculating a display range based on the eye point, the display range defining a space viewable by the driver through a range on the windshield in which the information is displayed by the head-up display device;
causing the head-up display device to display target object information at a position corresponding to the target object in a case where a position of the target object is outside the field-of-view range and inside the display range; and
causing the head-up display device to hide the target object information in a case where the position of the target object is inside the field-of-view range.
